(19) United States
(12) Patent Application Publication
(10) Pub. No.: US 2012/0145744 A1
(43) Pub. Date: Jun. 14, 2012

(54) LIQUID DISPENSER

(75) Inventor: Sean C. McGreevy, St. Paul, MN (US)

(73) Assignee: 3M Innovative Properties Company

(21) Appl. No.: 12/963,178

(22) Filed: Dec. 8, 2010

(51) Int. Cl. B67D 7/06

(52) U.S. Cl. 222/179.5

(57) ABSTRACT

Disclosed is a liquid dispenser that can be stored in an upside-down position so that the liquid settles adjacent the opening. Therefore, the liquid is readily accessible for instant dispensing. A cap is included to cover the opening during storage, and a polymeric holding film is attached to the cap by an attachment mechanism. The polymeric holding film is a smooth, flexible, and drapable polymeric film that allows for sliding along the work surface, but provides for holding against a force applied to the dispenser away from the work surface. When such a force is applied, the dispenser is removed from the cap, while the cap and polymeric holding film remain secured to the work surface. Therefore, with one hand the user can remove the dispenser from the cap and dispense the liquid.

### FIELD

The present disclosure relates to a liquid dispenser. In particular, the present disclosure relates to a liquid dispenser that includes a polymeric holding film that provides selective engagement of the dispenser with a working surface.

### BACKGROUND

Liquid dispensers are commonly used in home, industrial, medical, and construction fields. Typical dispensers are stored in an upright position so that the liquid settles to the bottom of the dispenser, away from the opening. Therefore, the liquid is not readily accessible for instant dispensing. Also, most liquid dispensers have a cap for covering the opening. The cap must be opened or removed prior to dispensing. Depending on the application, a user's hands may be holding the dispenser and holding the work piece. Therefore, the user may not have a free hand accessible for opening or removing the cap.

### SUMMARY

Disclosed is a liquid dispenser that can be stored in an upside-down position so that the liquid settles adjacent the opening. Therefore, the liquid is readily accessible for instant dispensing. A cap is included to cover the opening during storage. A polymeric holding film is attached to the cap by an attachment mechanism. The polymeric holding film is a smooth, flexible, and drapable polymeric film that, in one embodiment, allows for sliding along the work surface, but provides for holding against a force applied to the dispenser away from the work surface. When such a force is applied, the dispenser is removed from the cap, while the cap and polymeric holding film remain secured to the work surface. Therefore, with one hand the user can remove the dispenser from the cap and dispense the liquid contained therein.

In one embodiment, the liquid dispenser comprises a body for holding a liquid, an opening on the body for dispensing the liquid contained within the body, a cap removably engaged with the body, wherein the cap includes an inner surface adjacent the opening and an outer surface, opposite the inner surface, and a polymeric holding film having a first surface and a second surface, the first surface attached to the outer surface cap by an attachment mechanism and the second surface of the polymeric holding film disposed so as to be placed in direct contact with the work surface. The polymeric holding film is smooth, flexible, and drapable. In one embodiment the opening is elongated and tapered from the body. In one embodiment, the cap removably connects with the body. In one embodiment, the cap is directly adjacent the opening on the body. In one embodiment, second surface of the polymeric holding film provides selective engagement of the polymeric holding film with the work surface. In one embodiment, the polymeric holding film allows for sliding along the work surface, but provides for holding against a force applied to the dispenser away from the work surface. In one embodiment, the polymeric holding film has a flexural modulus less than about 50 MPa, as measured according to ASTMD790 standard, and a roughness parameter, Rₐ of less than about 1 micrometer, as calculated according to ASME B46.1 standard. In one embodiment, an area of the attachment mechanism that connects with the polymeric holding film is less than a total area of the polymeric holding film. In one embodiment, the area of the attachment mechanism that connects with the polymeric holding film is less than half the total area of the polymeric holding film. In one embodiment, the polymeric holding film extends beyond an outer edge of the cap.

In one embodiment, a method of holding the dispenser comprising the steps of securing the second surface of the polymeric holding film to the work surface. In one embodiment, the method further comprises sliding the dispenser along the work surface. In one embodiment, the method, further comprises applying a force away from the work surface and disengaging the cap from the body. In one embodiment, the method further comprises dispensing the liquid from the body. In one embodiment, the method further comprises pulling an edge of the polymeric holding film away from the work surface to release the connection of the polymeric holding film from the work surface.

### BRIEF DESCRIPTION OF THE DRAWINGS

FIG. 1 is a perspective view of a first embodiment of a dispenser engaged with a work surface;

FIG. 2 is a side view of the dispenser of FIG. 1;

FIG. 3 is a bottom view of the dispenser of FIG. 1, with the attachment mechanism shown in phantom;

FIG. 4 is a top view of the dispenser of FIG. 1;

FIG. 5 is a perspective view of the dispenser of FIG. 1.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention.

The figures may not be drawn to scale.

### DETAILED DESCRIPTION

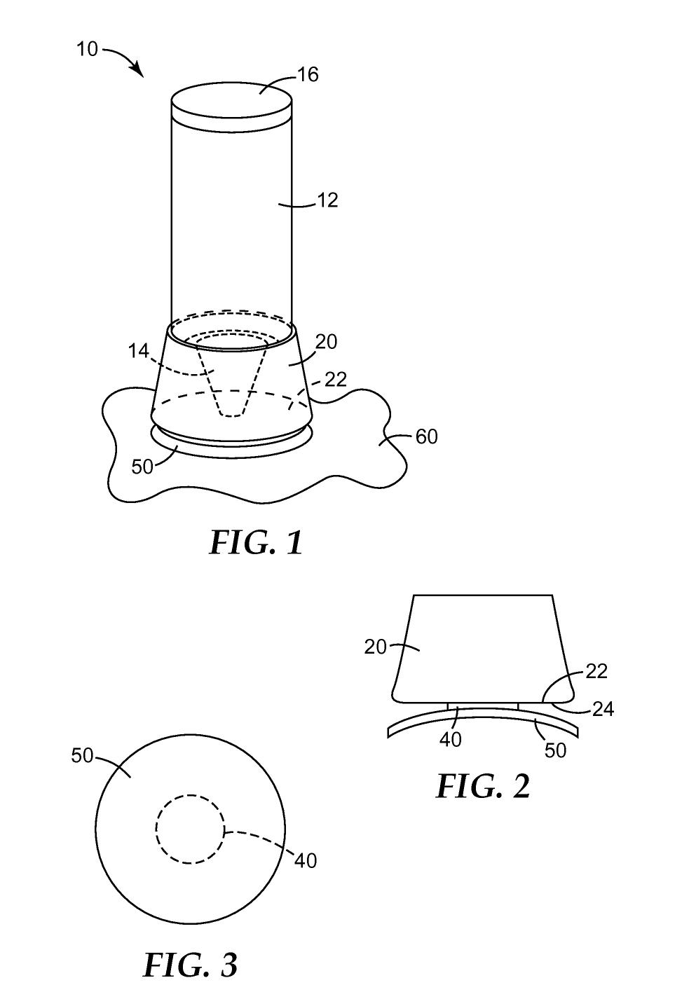

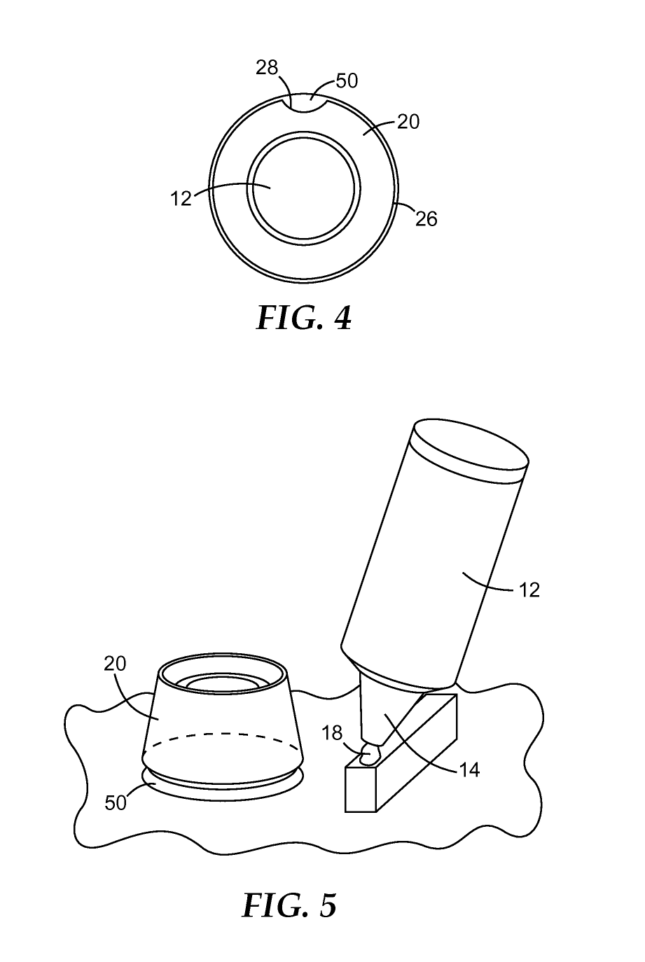

FIG. 1 is a perspective view a one embodiment of a liquid dispenser 10 engaged with a work surface 60. FIG. 2 is a side view of the liquid dispenser 10. FIG. 3 is a bottom view of the liquid dispenser 10, showing the polymeric holding film 50 and the attachment mechanism 40 shown in phantom. FIG. 4 is a top view of the liquid dispenser 10. FIG. 5 is a perspective view of the liquid dispenser 10 with the cap 20 removed.

The dispenser 10 includes a body 12 and an opening 14 in fluid communication with the liquid 18 contained within the body 12 of the dispenser 10. The dispenser 10 includes a cap 20 that can cover the opening 14 when the dispenser is not in use. The dispenser 10 further includes a polymeric holding film 50 attached to the cap 20 by an attachment mechanism 40. The polymeric holding film 50 allows for selective engagement of the cap 20 to a work surface 60.

A variety of dispenser 10 constructions can be provided depending on the properties of the enclosed liquid 18 and end use application. In one embodiment, the body 12 may be relatively deformable to allow for squeezing of the body 12 to dispense the liquid 18. In embodiments where the body 12 is deformable, the body 12 may reform its original shape or may permanently crush with the applied squeezing. In one embodiment, the body 12 may be relatively rigid but include a plunger at the end opposite the opening 14 to dispense the liquid 18, similar to a caulk dispenser.

The dispenser 10 may be a single use dispenser 10 or may include a portion removable from the body 12 to allow for filling of liquid 18 into the body 12 of the dispenser 10. In one embodiment, an optional filling cover 16 may be included at an end opposite the opening 14. In another embodiment, the opening 14 is removable from the body 12 to allow for filling of the liquid 18.

A variety of opening 14 constructions can be provided depending on the properties of the enclosed liquid 18 and end use application. In one embodiment, the opening 14 may be flush with the body 12 of the dispenser 10. In one embodiment, such as shown in FIG. 1, the opening 14 may be elongated from the body 12 of the dispenser 10. An elongated opening 14 may be generally cylindrical or may be tapered, such as shown in FIG. 1. A tapered, elongated opening 14 is particularly desirable when dispensing liquids because of the capillary action from the liquid, the liquid will tend to draw back into the elongated portion of the opening and not remain at the surface of the opening. It is understood that one of skill in the art would optimize the shape and construction of the opening as well as the size of the opening depending of the properties of the liquid and the end use application.

A cap 20 is included for covering the opening 14 when the dispenser 10 is not in use, such as shown in FIG. 1. The cap 20 is removably engaged with the body 12 of the dispenser. In one embodiment, the body 12 simply rests on the cap 20 either during use or during storage. In one embodiment, the cap 20 removably connects with the body 12. In embodiments where the cap 20 removably connects with the body 10 the cap 20 mechanically connects with the body 12 through such connections as a snap-fit, friction fit, or pressure lock fit. In one embodiment, the cap 20 can both provide for removable engagement and removable connection with the body. In one embodiment, the cap 20 can provide for both a cover to the opening and a docking station for the end of the body 12 opposite the cap 20 during use.

The cap 20 includes an inner surface 22 that is adjacent the opening 14. In one embodiment, the inner surface 22 is directly adjacent the opening 14 and therefore covers the opening 14. The inner surface 22 may include commonly used structures to prevent flow of the contained liquid 18 while the body 12 is in engagement with the cap 20 and for when the body 12 is connected with the cap 20. Such a construction may be desirable to securely contain the liquid 18 within the dispenser 10 during storage. The cap 20 includes an outer surface 24 that is opposite the inner surface 22.

The cap 20 includes an outer edge 26 that forms a perimeter of the cap 20. The cap 20 may include a cutout 28 at the outer edge 26 that generally recessed inward from the whole of the outer edge 26 and exposes the underlying polymeric holding film 50.

A polymeric holding film 50 is attached to the outer surface 24 of the cap 20 by an attachment mechanism 40. A suitable polymeric holding film and attachment mechanism are disclosed in U.S. patent application publication 2008-0011626, the disclosure of which is herein incorporated by reference.

Unlike the traditional suction cup that holds an item in only one place until the suction is broken, the polymeric holding film 50 and attachment mechanism 40 allows the cap 20 to slide when being pushed across a work surface 60, but provides for holding against a force applied to the cap 20 and/or dispenser 10 away from the work surface 60. Also, unlike the traditional suction cup, the polymeric holding film 50 is a smooth, flexible, and drapable film. Traditional suction cups are often applied to vertical work surfaces such that a smooth, flexible, and drapable film would fold and not hold on a vertical surface. The disclosed the polymeric holding film 50 and attached cap 20 are typically applied to horizontal work surfaces. As force is applied away from the work surface 60, the polymeric holding film 50 drapes downward against the work surface 60 in the area not held by the attachment mechanism 40. A continuous downward drape creates a seal against the work surface 60 and holding against the force applied away from the work surface 60. However, the polymeric holding film 50 remains slidable over the work surface 60.

The polymeric holding film is drapable. The polymeric holding film 50 has a flexural modulus less than 50 mega pascals (MPa), preferably less than 25 MPa, more preferably less than 10 MPa, and most preferably in the range of 5-7 MPa, as tested according ASTM D790 Standard Test Methods for Flexural Properties of Unreinforced and Reinforced Plastics and Electrical Insulating Materials. The preferred ranges denote polymeric holding film 50 that tends to have better drape of the film once attached to the cap 20. In brief summary, this test method involves a three-point bend test where the test conditions includes a span of 16 mm and a cross-head speed of 5 mm per minute and where the sample had a width of 25.4 mm and a length of 50 mm.

The polymeric holding film is smooth. The polymeric holding film 50 has an average roughness parameter (Rₐ) of less than 1 micrometer, calculated over the entire sample testing area. The roughness measurement is calculated according to ASME B46.1 standard. In brief summary, in conducting this test, a sample of the polymeric holding film 50 was first coated with a gold/palladium film (using a current of 40 mA and 10 second) and the polymeric holding film's surface topography or roughness was measured using a Wyko NT3300 optical interferometer operated in VSI mode with a 10× objection and a 2% modulation threshold.

Useful polymeric holding films 50 include rubbers made with ethylene propylene diene monomers (EPDM). The film has a Shore A durometer of less than 70. The polymeric holding film has a thickness of 0.01 to 0.1 inch (0.25 to 2.5 mm). Suitable, commercially available EPDM films include those available from McMaster-Carr, Atlanta, Ga. under product numbers 8610 K81 and 8143 K11. Preferably, the polymeric holding film 50 has minimal amount of plasticizers, which could, over time, alter the film's effectiveness to provide suction. Also, the polymeric holding film 50 should be sufficiently chemically inert over time so as not to stain the work surface upon which it is placed or to affect the attachment mechanism, such as the pressure sensitive adhesive tape.

The attachment mechanism 40 secures the polymeric holding film 50 to the cap 20. The attachment mechanism 40 can be mechanical based or adhesive based and may be permanent or removable. Suitable mechanical attachment mechanisms include recloseable fasteners, such as those described in U.S. Pat. No. 6,972,141 (Bries et al.). Another suitable attachment mechanism that combines mechanical and adhesive means include those commercially available from 3M Company under the Command™ brand, such as the picture hanging strips and the mounting and replacement strips. Because of the releasable nature of the recloseable fasteners and the Command™ products, the polymeric holding film 50 can be disengaged from the dispenser, allowing for interchanging with a new cap or with a new holding film. Yet another suitable attachment mechanism 40 is double sided tape, such as those commercially available from 3M Company under product number 4462W and 4466W. Selection of the appropriate attachment mechanism 40 depends on the user's preference as well as the intended application.

The design and size of the attachment mechanism 40 relative to the polymeric holding film 50 can affect the amount of suction generated between the polymeric holding film 50 and the work surface 60 when a substantially normal force is imposed on the item. After the polymeric holding film 50 is attached to the cap 20, a side view (see FIG. 2) shows that the polymeric holding film 50 crowns slightly toward the attachment mechanism 40. Polymeric holding films 50 that provide sufficient suction force to hold the cap 20 in place during use are films that have physical properties, in terms of flexural modulus, that allow them to drape under normal gravitational forces. Furthermore, the most effective holding films are films that have flexural modulus less than 10 MPa and surface roughness value (Rₐ) of less than one micrometer.

Further, to allow for the drape of the polymeric holding film under normal gravitational forces, an area of the attachment mechanism 40 that connects with the polymeric holding film 50 is less than the total areas of the polymeric holding film 50. In another embodiment, the area of the attachment mechanism 40 that connects with the polymeric holding film 50 is less than half the total area of the polymeric holding film 50. In another embodiment, the ratio of the surface area of the polymeric holding film 50 to the surface area of the attachment mechanism 40 is from 10:1 to 3:1.

The polymeric holding film 50 and/or attachment mechanism 40 can have any number of sizes or shapes. Generally, the size of the polymeric film 50 relative to the size of the cap 20, and the ratio of the surface area of the attachment mechanism 40 to the surface area of the polymeric hold film 50 impact the holding strength of the polymeric holding film 50. In one embodiment, polymeric holding film has a circular geometry. In one embodiment, the attachment mechanism 40 has either circular or square geometry. The attachment mechanism 40 is typically positioned nearly at the center of the polymeric holding film 50 and cap 20.

It is understood that one of skill in the art could optimize the sizes of the polymeric holding film 50 and attachment mechanism 40 to achieve the desired level of sliding and holding. Further, if the cap 20 is removably connected to the body 12, one of skill in the art could optimize the strength of the mechanical connection between the cap 20 and body 12 of the dispenser in combination with the size of the polymeric holding film 50 and attachment mechanism 40 to achieve the desired level of sliding and holding.

To use the liquid dispenser 10 and cap 20 with attached polymeric holding film 50, the user places the polymeric holding film 50 in contact with a work surface. The user then can exert a force away from the work surface 60 thereby causing the polymeric holding film 50 to drape downwardly towards the work surface 60 and create a seal to hold against the force. The applied force causes the dispenser 10 to disengage from the cap 20 to allow the liquid 18 to be dispensed, as shown in FIG. 5. Therefore, by using one hand holding the body 12 of the liquid dispenser 10, the user is able to disconnect the cap 20 from the dispenser. Further, because the opening 14 is adjacent the cap 20, the liquid is readily accessible for dispensing.

With either the body 12 engaged with the cap 20 or disengaged from the cap 20, the user can take hold of the cap 20 and slide or push it across a work surface 60. By doing so, the user exerts a lateral force on the cap 20 and attached polymeric holding film 50.

To break the connection between the work surface 60 and the polymeric holding film 50, a user could slide the polymeric holding film 50 off an edge of the work surface 60. Alternatively, a user could lift the polymeric holding film 50 at the area at the cutout 28, if included, to break the seal. It is understood that more than one cut-out could be provided.

The polymeric holding film 50 can be used to secure to a variety of work surfaces. Examples of work surfaces include that that allow for the polymeric holding film 50 to drape downwardly and create a seal. Generally, the work surface is substantially flat and planar. Examples of surfaces include glass, plastic, wood surfaces.

The disclosed liquid dispenser 10 can be used to dispenser a variety of liquids 18. It is understood that liquid is intended to include any numbers a viscous or flowable substances. The liquid could be any variety of liquids that are typically dispensed, and especially for one-handed holding of the dispenser and removal of the cap. Examples include: foods such as whipped cream, cake frosting, or condiments like mayonnaise, ketchup, mustard, syrup; cleaning products such a soaps, detergents, liquid scouring solutions; personal care products dispensed in liquid form such as soap, lotion, sanitizer, shampoo, hair conditioner, liquid makeup; construction materials dispensed in liquid form such as adhesives and sealants. The liquid dispenser could be used in a variety of settings, such as, for example, home, commercial, industrial, or medical applications.

Although specific embodiments of this invention have been shown and described herein, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

What is claimed is:

1. A liquid dispenser comprising:
a body for holding a liquid;
an opening on the body for dispensing the liquid contained within the body;
a cap removably engaged with the body, wherein the cap includes an inner surface adjacent the opening and an outer surface, opposite the inner surface;
a polymeric holding film having a first surface and a second surface, the first surface attached to the outer surface cap by an attachment mechanism and the second surface of the polymeric holding film disposed so as to be placed in direct contact with the work surface, wherein the polymeric holding film is smooth, flexible, and drapable.

2. The dispenser of claim 1, wherein the opening is elongated and tapered from the body.

3. The dispenser of claim 1, wherein the cap removably connects with the body.

4. The dispenser of claim 1, wherein the cap is directly adjacent the opening on the body.

5. The dispenser of claim 1, wherein the second surface of the polymeric holding film provides selective engagement of the polymeric holding film with the work surface.

6. The dispenser of claim 1, wherein the polymeric holding film allows for sliding along the work surface, but provides for holding against a force applied to the dispenser away from the work surface.

7. The dispenser of claim 1, wherein the polymeric holding film has a flexural modulus less than about 50 MPa, as measured according to ASTMD790 standard, and a roughness parameter, Rₐ of less than about 1 micrometer, as calculated according to ASME B46.1 standard.

8. The dispenser of claim 1, wherein an area of the attachment mechanism that connects with the polymeric holding film is less than a total area of the polymeric holding film.

9. The dispenser of claim 8, wherein the area of the attachment mechanism that connects with the polymeric holding film is less than half the total area of the polymeric holding film.

10. The dispenser of claim 1, wherein the polymeric holding film extends beyond an outer edge of the cap.

11. A method of holding the dispenser of claim 1, comprising the steps of:
securing the second surface of the polymeric holding film to the work surface.

12. The method of claim 11, further comprising:
sliding the dispenser along the work surface.

13. The method of claim 11, further comprising:
applying an force away from the work surface;
disengaging the cap from the body.

14. The method of claim 13, further comprising:
dispensing the liquid from the body.

15. The method of claim 11, further comprising:
pulling an edge of the polymeric holding film away from the work surface to release the connection of the polymeric holding film from the work surface.
